(19) United States
(12) Patent Application Publication
(10) Pub. No.: US 2016/0170821 A1
(43) Pub. Date: Jun. 16, 2016

(54) PERFORMANCE ASSESSMENT

(71) Applicant: Tata Consultancy Services Limited, Mumbai (IN)

(72) Inventors: Shreekant Shiralkar, Goregaon(E) (IN); Prasad Vishwas Sahastrabuddhe, Thane west (IN); Deepak Sawant, Hinjewadi (IN)

(21) Appl. No.: 14/657,125

(22) Filed: Mar. 13, 2015

(30) Foreign Application Priority Data
Dec. 15, 2014 (IN) 4034/MUM/2014

(51) Int. Cl. G06F 11/07

(52) U.S. Cl. CPC G06F 11/079; G06F 11/0751; G06F 11/0787; G06F 11/0793

(57) ABSTRACT

A method for assessing performance of a decision support system is disclosed. In an implementation, the computer implemented method includes obtaining relevant application data from among application data associated with a business intelligence application operating on the decision support system. Further, a plurality of performance parameters and a threshold value for each of the plurality of dynamically identified performance parameters is dynamically identifier for the application based on historical performance data associated with the business intelligence application. The relevant application data is sorted based on the plurality of dynamically identified performance parameters. Further, the performance of the decision support system is assessed based on the plurality of dynamically identified performance parameters and the sorted application data, to rectify the performance of the decision support system.

### TECHNICAL FIELD

The present subject matter relates, in general, to performance assessment and, particularly but not exclusively, to performance assessment of decision support systems.

### BACKGROUND

Businesses have been using automation for operations for a long time. Enterprises have adopted data processing, automation packages, Management Information Systems (MIS), Enterprise Resource Planning (ERP), and Internet-delivered services. This has helped the businesses in improving the efficiency of the processes and contributed to faster cycle times. Rapid growth in the volume of data involved in such automated systems has prompted organizations to deploy decision support systems (DSS) to enable informed decision making. The DSS performs tasks of collecting, integrating, and transforming information for decision making. A data warehouse can be a functional component of the DSS.

However, as the DSS is used over a period of time, it may deliver suboptimal performance. This may be because of design inconsistencies or variance in unaddressed functional usages due to lack of regular housekeeping. Such suboptimal performances may lead to high data loading time, slow report generation, and may negatively impact priority business processes. Therefore, business organizations usually have to regularly tune the performance of the DSS.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a performance assessment system for assessing performance of a decision support system, in accordance with an implementation of the present subject matter.

FIG. 2 illustrates a method for assessing performance of a decision support system, in accordance with an implementation of the present subject matter.

FIGS. 3a and 3b illustrate results of the performance assessment, in accordance with an example of the present subject matter.

### DETAILED DESCRIPTION

The present subject matter relates to performance assessment of decision support systems.

Generally, decision support systems lose performance capabilities over a period of time and may be unable to match the expectations of cost and time associated with their operation. A data warehouse may be a functional component of the DSS and the performance of the DSS may be substantially dependent on the performance of the data warehouse. Therefore, regular performance assessment and tuning of the DSS has to be done. As part of performance assessment and turning, factors that erode the performance of the DSS can be identified. The identification of such factors affecting performance of the DSS can involve identifying performance bottleneck, root cause, and possible resolutions.

Conventionally, such identification of the factors affecting performance of the DSS is done manually. However, the manual process of identification can involve experienced and skilled resources, such as professionals, and may take a considerably long time for completion. As a result, the overall cost of the activity of performance assessment may be substantially high and the effectiveness of the activity may be adversely affected. Additionally, manual analysis may overlook certain factors that impact the performance of the DSS and may be subject to variations and personal preferences depending on the person executing the analysis. Therefore, the analysis and the recommendations may neither be consistent nor repeatable.

The present subject matter provides an approach for effectively assessing the performance of the decision support systems by automating the performance activity. For example, the activities of identifying performance bottleneck, root cause, and possible resolutions can be automated, thereby, eliminating involvement of high skilled resources and considerably reducing the cost and time associated with the performance assessment activities. The present subject matter facilitates in identifying the factors that impact the performance of the DSS and reports the analysis, involving a few hours in the entire process. The performance assessment, in accordance with the present subject matter, can be achieved without involving much expertise on DSS and associated performances. The present subject matter can comprehensively and consistently capture the factors affecting the performance of the DSS. The performance assessment, in accordance with the present subject matter, can automate data collection from the DSS, achieve analysis, and based on the analysis provide recommendations for enhancing performance of the DSS.

In an implementation of the present subject matter, relevant application data with a business intelligence application operating on the DSS based on which the performance of the DSS is to be assessed is obtained, say from a DSS server. The relevant application data can be obtained from among the entire application data available for the business intelligence application. The relevant application data can be selected from the entire set of application data based on predefined rules. For example, the rules can vary from application to application, on the basis of the application for which the relevant application data is to be obtained.

Further, the relevant application data obtained from the DSS can be stored locally. Accordingly, a database can be setup for storing the relevant application data. As part of the setting-up of the database, a plurality of performance parameters and a threshold value for each of the plurality of dynamically identified performance parameters can be dynamically identified for the business intelligence application. According to an aspect, the performance parameters and their respective threshold values can be based on historical performance data associated with the business intelligence application. For instance, current industry standard performance parameters for similar business intelligence application and currently prevalent performance expectations can be the basis for determining the performance parameters and the threshold values. In addition, according to the above mentioned implementation, one or more machine learning techniques can be employed on the historical data for determining the performance parameters and the threshold values. Once the performance parameters and the threshold values have been determined, a table can be created in the database for storing the performance parameters along with the respective threshold values for easy and convenient accessibility.

Further, the relevant application data is sorted before being stored in the database. The relevant application data can be sorted based on the plurality of dynamically identified performance parameters. In an example, the relevant application data which corresponds to or is pertinent to a certain performance parameter is sorted to be stored with that performance parameter, again, for the purpose of providing ease of accessibility. In another example, the relevant application data can be converted into a performance indicator based on the pertinent performance parameter, as part of sorting of the relevant application data.

Subsequently, the performance of the decision support system based on the plurality of dynamically identified performance parameters and the sorted application data, to rectify the performance of the decision support system. In addition, a report indicative of the performance of the decision support system can be generated and prepared. The report may also include recommendations for rectifying, for example, for enhancing, the performance of the decision support system.

Further, according to an aspect of the present subject matter, the threshold values of each of the plurality of dynamically identified performance parameters can be regularly benchmarked, for example, after predetermined intervals of time, based on historical data associated with the business intelligence application. For example, the trend of the performance parameters and the values of the threshold parameters, currently prevalent performance requirements, system configurations and capabilities, and support system configuration and capabilities can be taken into account for benchmarking the threshold values of the performance parameters.

The present subject matter provides for reduction in cost, for instance, in total cost of ownership (TCO), of the DSS by increasing productivity, and can facilitate in the identification of areas where the DSS can be leveraged more effectively. The present subject matter can provide a preview of the effectiveness of the existing DSS support and services and how well they are geared for the future. The present subject matter can identify current pain areas, root cause analysis, and possible solutions for enhancing the performance of the DSS.

These and other advantages of the present subject matter would be described in greater detail in conjunction with the following figures. While aspects of described systems and methods for identification of an activity performed by a subject can be implemented in any number of different computing systems, environments, and/or configurations, the embodiments are described in the context of the following device(s).

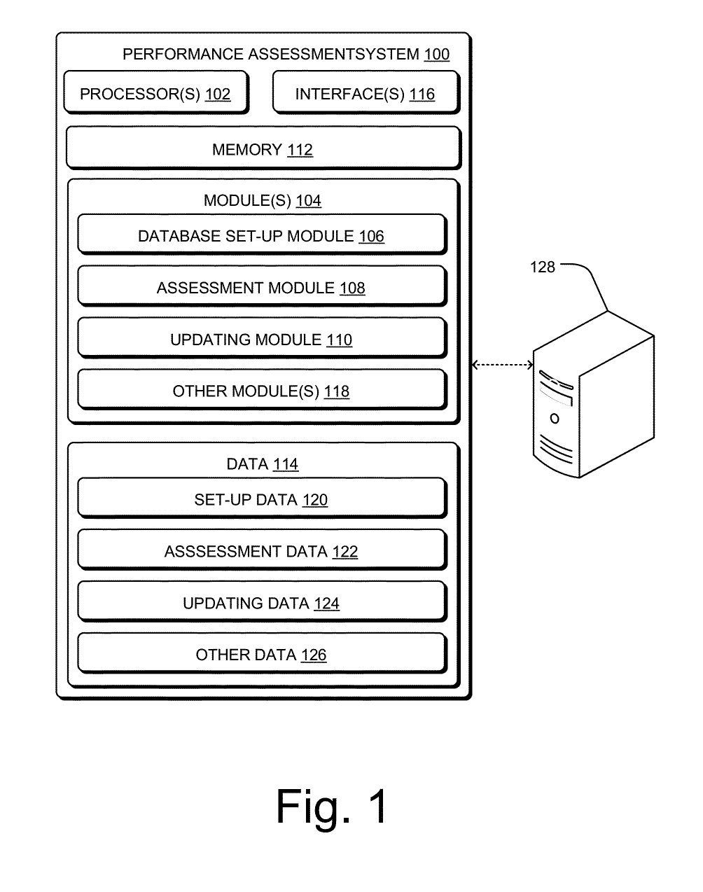

FIG. 1 illustrates a performance assessment system 100 for selective profiling of an application, in accordance with an implementation of the present subject matter. In said implementation, the performance assessment system 100, hereinafter referred to as system 100, can be implemented as a computing device, such as a laptop computer, a desktop computer, a notebook, a workstation, a mainframe computer, a server, and the like.

Further, in said implementation, the system 100 includes processor(s) 102 and memory 112. The processor 102 may be implemented as one or more microprocessors, microcomputers, microcontrollers, digital signal processors, central processing units, state machines, logic circuitries, and/or any devices that manipulate signals, based on operational instructions. Among other capabilities, the processor(s) 102 is provided to fetch and execute computer-readable instructions stored in the memory 112. The memory 112 may be coupled to the processor 102 and can include any computer-readable medium known in the art including, for example, volatile memory, such as Static Random Access Memory (SRAM) and Dynamic Random Access Memory (DRAM), and/or non-volatile memory, such as Read Only Memory (ROM), erasable programmable ROM, flash memories, hard disks, optical disks, and magnetic tapes.

Further, the system 100 may include module(s) 104 and data 114. The modules 104 and the data 108 may be coupled to the processors 102. The modules 104, amongst other things, include routines, programs, objects, components, data structures, etc., which perform particular tasks or implement particular abstract data types. The modules 104 may also, be implemented as, signal processor(s), state machine(s), logic circuitries, and/or any other device or component that manipulate signals based on operational instructions.

In an implementation, the module(s) 106 include a database set-up module 106, an assessment module 108, an updating module 110, and other module(s) 118. The other module(s) 118 may include programs or coded instructions that supplement applications or functions performed by the system 100. Additionally, in said implementation, the data 114 includes set-up data 120, assessment data 122, updating data 124, and other data 126. The other data 126 amongst other things, may serve as a repository for storing data that is processed, received, or generated, as a result of the execution of one or more modules in the module(s). Although the data 114 is shown internal to the system 100, it may be understood that the data 114 can reside in an external repository (not shown in the figure), which may be operably coupled to the system 100. Accordingly, the system 100 may be provided with interface(s) (not shown) to communicate with the external repository to obtain information from the data 114.

In addition, in an implementation, the system 100 can be coupled to a server 128 of the decision support system (DSS) to access the DSS and perform assessment analytics on the DSS.

In accordance with an aspect of the present subject matter, the system 100 can provide an approach for identifying and analyzing application performance for a DSS running a business intelligence application. The approach involves identification, by the system 100, of one or more elements that affect performance of the DSS, from within multiple layers of the application, involving extraction of such elements to obtain resource usage information. In addition, the system 100 is capable of comparing and analyzing performance of the DSS against existing performance benchmark(s) and best-in-class parameters of performance. Accordingly, the system 100 can facilitate in generating consistent and accurate assessment of the target DSS and can considerably reduce the cost incurred and the time taken by conventional techniques by about 40% to 60%. In addition, the system 100 can update the performance benchmark(s) on a continual basis, i.e., the performance benchmark(s) are dynamically revised. The system can continuously update performance benchmarks based on rule based logic to provide an up-to-date measure for the performance of the DSS. In addition, the system 100 can implement a technique to review and vary coverage of factors that influence the performance of the application, also referred to as the performance parameters. In other words, the system 100 can account for technological advancements that influence the performance. In addition, the system 100 can identify a correlation between the various performance parameters, say using association techniques, to identify the change in the performance that influence the performance. Further, the system 100 can implement a “what-if” simulation and analysis to identify an appropriate scenario for an enhancement of the overall system performance rather than improving performance by troubleshooting few performance parameters.

In operation, the database set-up module 106 can obtain relevant application data with a business intelligence application operating on the DSS, based on which the performance of the DSS is to be assessed, say from the server 128. The relevant application data can be obtained from among the entire application data available for the business intelligence application. The relevant application data can be selected from the entire set of application data based on predefined rules and store din the set-up data 120.

Further, as mentioned, the relevant application data obtained from the DSS can be stored locally, say in the set-up data 120. Accordingly, the database set-up module 106 can set up the set-up data 120 as a database for storing the relevant application data. As part of the setting-up of the database, database set-up module 106 can dynamically identify a plurality of performance parameters and a threshold value for each of the plurality of dynamically identified performance parameters for the business intelligence application. According to an aspect, the database set-up module 106 can identify the performance parameters and their respective threshold values based on historical performance data associated with the business intelligence application. For instance, current industry standard performance parameters for similar business intelligence application and currently prevalent performance expectations can be the basis for determining the performance parameters and the threshold values. In addition, according to the above mentioned implementation, the database set-up module 106 can employ one or more machine learning techniques can be employed on the historical data for determining the performance parameters and the threshold values. Once the performance parameters and the threshold values have been determined, the database set-up module 106 can create a table in the database, i.e., the set-up data 120, for storing the performance parameters along with the respective threshold values for easy and convenient accessibility.

In an example, for a Systems Applications & Products (SAP) Business Warehouse application, the performance parameters can include Lower Cases, Indexing of Operational Data Store (ODS) objects, Usage of Navigational Attributes in Infoproviders, Cube Partitioning, Cube Compressed, Aggregate Usage, Unused Aggregates, Active Aggregates, Multiprovider Usage, Reporting Relevance of ODS objects, Usage of Navigational Attributes, User Entry Variables Redundancy, Variables by Processing Type, Variables Changeability during Navigation, User Entry Variables per Query, Average Variables per Query, Query Execution Filter Value Selection, Query Definition Filter Value Selection, Query over Business Explorer (BEx) flagged ODS objects, Provider with Or without Queries, All reports, Reporting Components, Query element references, Global Variables, and Reporting component elements.

Further, the database set-up module 106 can sort the relevant application data before storing the data in the database. The database set-up module 106 can sort the relevant application data based on the plurality of dynamically identified performance parameters. In an example, the database set-up module 106 can sort the relevant application data which corresponds to or is pertinent to a certain performance parameter to be stored with that performance parameter, again, for the purpose of providing ease of accessibility. In another example, the database set-up module 106 can convert the relevant application data into a performance indicator based on the pertinent performance parameter, as part of sorting of the relevant application data.

Subsequently, the assessment module 108 can assess the performance of the decision support system based on the plurality of dynamically identified performance parameters and the sorted application data, to rectify the performance of the decision support system. In addition, the assessment module 108 can generate a report indicative of the performance of the decision support system. In an example, the report can be in Microsoft Word, Microsoft Excel, or Acrobat Reader format. The report may also include recommendations for rectifying, for example, for enhancing, the performance of the decision support system.

Further, according to an aspect of the present subject matter, the updating module 110 can benchmark the threshold values of each of the plurality of dynamically identified performance parameters, for example, after predetermined intervals of time, based on historical data associated with the business intelligence application. For example, the updating module 110 can take into account the trend of the performance parameters and the values of the threshold parameters, currently prevalent performance requirements, system configurations and capabilities, and support system configuration and capabilities for benchmarking the threshold values of the performance parameters.

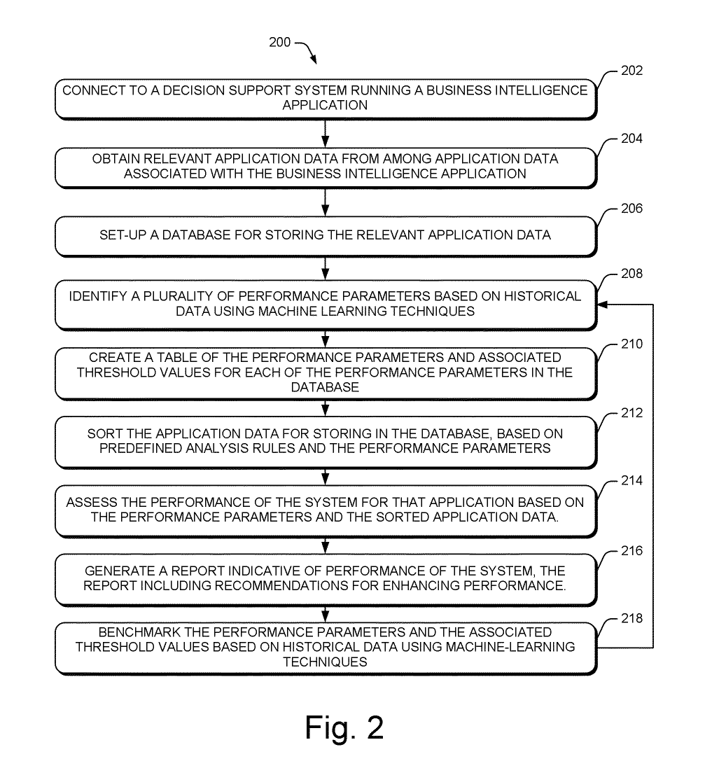

FIG. 2 illustrates a method 200 for assessing performance of a decision support system, according to an embodiment of the present subject matter. The order in which the method is described is not intended to be construed as a limitation, and any number of the described method blocks can be combined in any order to implement the method or any alternative method. Additionally, individual blocks may be deleted from the method without departing from the spirit and scope of the subject matter described herein. Furthermore, the method can be implemented in any suitable hardware, software, firmware, or combination thereof.

The method 200 may be described in the general context of computer executable instructions. Generally, the computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, the computer executable instructions may be located in both local and remote computer storage media, including memory storage devices.

In an implementation, one or more of the methods described herein may be implemented at least in part as instructions embodied in a non-transitory computer-readable medium and executable by one or more computing devices. In general, a processor, for example, a microprocessor, receives instructions, from a non-transitory computer-readable medium, for example, a memory, and executes those instructions, thereby performing one or more methods, including one or more of the methods described herein. Such instructions may be stored and/or transmitted using any of a variety of known computer-readable media.

With reference to the description of FIG. 2, for the sake of brevity, the details of the components of the performance assessment system 100 are not discussed here. Such details can be understood as provided in the description provided with reference to FIG. 1.

Referring to FIG. 2, at block 202, a connection is established with the decision support system (DSS) running a business intelligence application, the DSS being the system which is to be assessed for performance.

At block 204, relevant application data with a business intelligence application operating on the DSS based on which the performance of the DSS is to be assessed is obtained, say from a DSS server.

At block 206, a database can be setup for storing the relevant application data.

At block 208, a plurality of performance parameters and a threshold value for each of the plurality of dynamically identified performance parameters can be dynamically identified for the business intelligence application. According to an aspect, the performance parameters and their respective threshold values can be based on historical performance data associated with the business intelligence application, using machine learning techniques.

At block 210, a table can be created in the database for storing the performance parameters along with the respective threshold values for easy and convenient accessibility.

At block 212, the relevant application data is sorted before being stored in the database. The relevant application data can be sorted based on the plurality of dynamically identified performance parameters. In an example, the relevant application data which corresponds to or is pertinent to a certain performance parameter is sorted to be stored with that performance parameter.

At block 214, the performance of the decision support system based on the plurality of dynamically identified performance parameters and the sorted application data, to rectify the performance of the decision support system

At block 216, a report indicative of the performance of the decision support system can be generated and prepared. The report may also include recommendations for rectifying, for example, for enhancing, the performance of the decision support system.

Further, at block 218, the threshold values of each of the plurality of dynamically identified performance parameters can be regularly benchmarked, for example, after predetermined intervals of time, based on historical data associated with the business intelligence application.

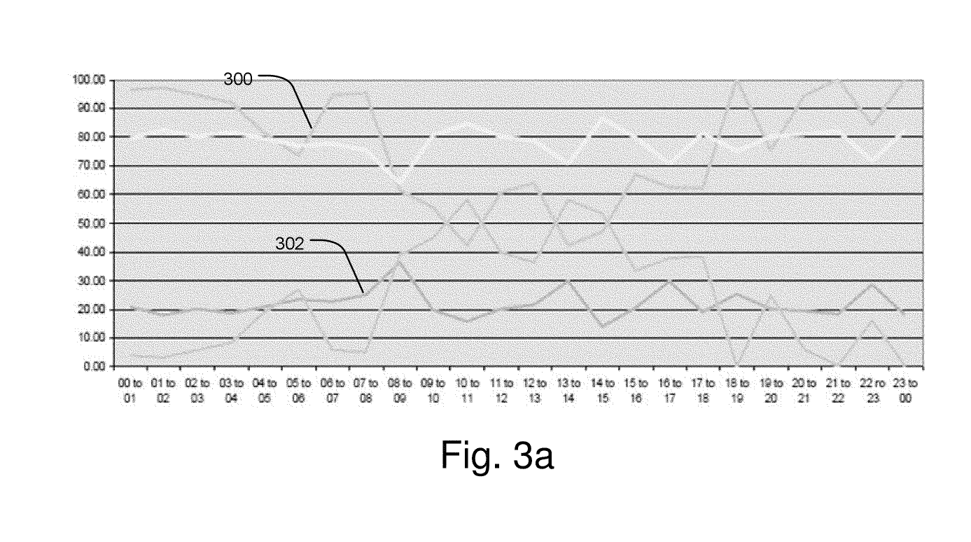

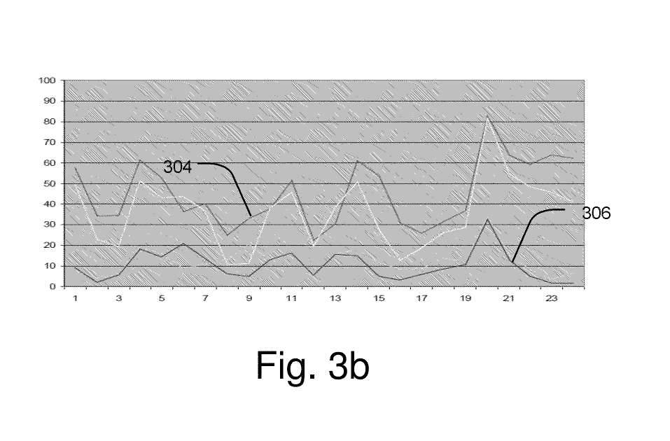

FIGS. 3a and 3b illustrates results of the performance assessment, in accordance with an example of the present subject matter.

The results depicted in FIGS. 3a and 3b illustrate variation of performance of the DSS, say before and after enhancement of performance of the DSS based on the performance assessment with reference to the present subject matter. As can be seen, in FIG. 3a, percentage of jobs running on a database server for the DSS is reduced from about 80% (shown by curve 300) to around 25% (shown by curve 302). Therefore, the database server is not available for taking other tasks for execution. Similarly, results illustrated in FIG. 3b show that after the implementation of changes recommended as part of the present subject matter, average CPU utilization of the database server can reduce from about 65% (as shown by curve 304) to about 45% (as shown by curve 306). Consequently, the performance of the database server, and therefore, the DSS, in supporting the business intelligence application and in executing the related tasks is considerably high. Further, since the average CPU utilization of the database server and the percentage of jobs running on the database server is considerably low, the available database server resources can be used for other purposes, say for handling other tasks.

Although implementations for methods and systems for assessing performance of a decision support system are described, it is to be understood that the present subject matter is not necessarily limited to the specific features or methods described. Rather, the specific features and methods are disclosed as implementations for assessing performance of a decision support system.

I/We claim:

1. A computer implemented method for assessing performance of a decision support system, the computer implemented method comprising:
obtaining, by a processor, relevant application data from among application data associated with a business intelligence application operating on the decision support system;
identifying, dynamically, by the processor, a plurality of performance parameters and a threshold value for each of the plurality of dynamically identified performance parameters for the business intelligence application based on historical performance data associated with the business intelligence application;
sorting, by the processor, the relevant application data based on the plurality of dynamically identified performance parameters; and
assessing, by the processor, the performance of the decision support system based on the plurality of dynamically identified performance parameters and the sorted application data, to rectify the performance of the decision support system.

2. The computer implemented method as claimed in claim 1, wherein the obtaining comprises:
setting-up a database for storing the relevant application data; and
creating a table of the plurality of dynamically identified performance parameters and the threshold value of each of the dynamically identified plurality of performance parameters.

3. The computer implemented method as claimed in claim 1, wherein the identifying is based on machine learning techniques.

4. The computer implemented method as claimed in claim 1 further comprising benchmarking, by the processor, the threshold values of each of the plurality of dynamically identified performance parameters based on historical data associated with the business intelligence application.

5. The computer implemented method as claimed in claim 1, further comprising generating, by the processor, a report indicative of the performance of the decision support system, the report including recommendations for rectifying the performance of the decision support system.

6. A performance assessment system for assessing performance of a decision support system, the performance assessment system comprising:
a processor;
a database set-up module coupled to the processor to,
obtain relevant application data from among application data associated with a business intelligence application operating on the decision support system;
identify, dynamically, a plurality of performance parameters and a threshold value for each of the plurality of dynamically identified performance parameters, based on historical performance data associated with the business intelligence application; and
sort the relevant application data based on the plurality of dynamically identified performance parameters; and
an assessment module coupled to the processor to assess the performance of the decision support system based on the plurality of dynamically identified performance parameters and the sorted application data, to rectify the performance of the decision support system.

7. The performance assessment system as claimed in claim 6, wherein the database set-up module is to:
set-up a database for storing the relevant application data; and
create a table of the plurality of dynamically identified performance parameters and predefined threshold value of each of the plurality of dynamically identified performance parameters.

8. The performance assessment system as claimed in claim 6, wherein the database set-up module is to identify the plurality of dynamically identified performance parameters and predefined threshold value of each of the plurality of dynamically identified performance parameters based on machine learning techniques.

9. The performance assessment system as claimed in claim 6, wherein the assessment module is to:
generate a report indicative of the performance of the decision support system; and
provide recommendations for rectifying the performance of the decision support system.

10. The performance assessment system as claimed in claim 6 further comprising an updating module, coupled to the processor, to benchmark the threshold values of each of the plurality of dynamically identified performance parameters based on historical data associated with the business intelligence application.

11. A non-transitory computer-readable medium having embodied thereon a computer program for executing a method for assessing performance of a decision support system, the method comprising:
obtaining relevant application data from among application data associated with a business intelligence application operating on the decision support system;
identifying, dynamically, a plurality of performance parameters and a threshold value for each of the plurality of dynamically identified performance parameters for the business intelligence application based on historical performance data associated with the business intelligence application;
sorting the relevant application data based on the plurality of dynamically identified performance parameters; and
assessing the performance of the decision support system based on the plurality of dynamically identified performance parameters and the sorted application data, to rectify the performance of the decision support system.
